(19) United States
(12) Patent Application Publication
(10) Pub. No.: US 2008/0118897 A1
(43) Pub. Date: May 22, 2008

(54) Method and system for teaching a game of chance

(76) Inventor: Reynaldo J. Perales, San Antonio, TX (US)

Correspondence Address: MALLOY & MALLOY, P.A., 2800 S. W. Third Avenue, Historic Coral Way, Miami, FL, 33126, US

(21) Appl. No.: 11/731,780

(22) Filed: Mar. 30, 2007

Related U.S. Application Data
(60) Provisional application No. 60/859,651, filed on Nov. 17, 2006.

(51) Int. Cl. G09B 19/22

(52) U.S. Cl. 434/129; 434/128

(57) ABSTRACT

A system and method for teaching a game of chance, the system comprising a network, a game teaching processor, a teacher interface, and a student interface. The game teaching processor is structured to facilitate interactive educational instruction relating to a game of chance. Additionally, the student interface and the teacher interface are structured to display interactive multimedia content, and also structured to permit real-time communication between teachers and students.

### BACKGROUND OF THE INVENTION

The present application is based on and a claim to priority is made under 35 U.S.C. Section 119(e) to provisional patent application currently pending in the U.S. Patent and Trademark Office having Ser. No. 60/859,651 and a filing date of Nov. 17, 2006.

### FIELD OF THE INVENTION

The present invention is directed to a method and system for teaching a game of chance wherein at least one student participates in learning the game of chance remotely from the teacher, thereby providing a more flexible, convenient, and interactive learning experience, while also reducing the attendant costs.

### DESCRIPTION OF THE RELATED ART

While gambling has been a popular leisure activity throughout the ages, modern gaming is presently enjoying unprecedented growth in popularity as well as growing acceptance by mainstream society. Associated with this growth in popularity is the rebirth of casinos in major urban entertainment centers, booming development of destination resorts featuring gaming as a major attraction, and, with the emergence of the Internet in the past decade, a plethora of online gaming venues. Moreover, certain games of chance, such as Texas Hold'em poker, have gained such popularity as to form the centerpiece of social get-togethers among friends and colleagues. Other common examples of popular games of chance include blackjack, craps, roulette, and slot machines. However, in terms of entertainment as a spectator sport, Texas Hold'em poker has emerged as perhaps the most popular tournament-style game of chance.

The popularity of Texas Hold'em poker and other games of chance in turn has fueled a boom in the gaming industry itself, with consumer influence as far reaching as television, Internet, books, seminars, and home gaming. From brick and mortar operations to Internet gaming sites, from seminars taught by professional players to myriad books and magazines, from television programs to portable casino kits; the gaming industry continues to flourish. Furthermore, gaming has become a global business with worldwide customers. For example, poker-based television series currently showcase competitors having origins from around the globe, and draw on a worldwide audience, generating wealth and celebrity for an increasing number of industry participants.

In association with the rise in popularity of gaming, more and more players are looking to improve their gambling skills to gain an advantage over their friends, rivals, and would-be competitors. From beginners who just want to learn the basics of their favorite game to advanced gamers who are looking to gain an edge over their peers, one common trait all participants share is the need for learning how to play their game of choice.

Traditionally, most learning has been achieved through trial and error participation. For example, a person can learn to play poker with friends or on the Internet by simple trial and error, hoping to learn via experience from cumulative mistakes and successes. More recently, students of gaming have been able to read books on their game of choice or even watch television shows on the subject. However, as in any endeavor, self-taught learning is not the most efficient way to learn, especially if one seeks to obtain a high skill level. Moreover, many people will hit a plateau when learning on their own and not be able to improve further unless they obtain instruction from a teacher.

One of the common instructional methods for teaching games of chance is the seminar, sometimes known as a “camp,” for which participants pay large amounts of money, often in excess of several thousand dollars. These seminars are often taught by well-known professionals. Some of the drawbacks associated with seminars are limited class size, limited time and date availability of the instructors, and limited ability of students to attend the scheduled seminar. Other disadvantages include the cost of the venue which gets passed onto students, as well as other expenses such as travel to and from the facilities, lodging, etc.

It would therefore be advantageous for a system and method for teaching a game of chance to permit remote access by students such that the students could access instruction at a convenient time and from a convenient location. It would also be an advantage for such a system and method to employ multimedia content such as audio, graphics, video, and text for a content-rich teaching and learning environment. It would also be beneficial for such a method and system to enable interactive educational instruction so that students could participate in active learning, yet still have the option to participate as an observer. A further benefit for such a system and method would be for the instruction to take place in real-time, enabling live communication between or among the students and teachers.

In addition to the cost and scheduling problems associated with traditional methods of teaching games of chance, there are other disadvantages associated with traditional teaching methods. For example, sometimes a student will have a question but is embarrassed to ask their question in front of the entire class, or is afraid they will slow the rest of the class down. As such, there is a need for private communication between a student and the teacher during a lesson that does not involve the other students.

Also, the teacher may want to illustrate a variety of plays or strategies for a given situation. Indeed, the ability to control game activity in a manner that is quick and efficient would be an important attribute to the pace of teaching as well as a benefit to the value of the learning experience. In the case of card games, it would additionally be advantageous for the teacher to be able to view every student's cards while each student can only see their own cards. Likewise, it would be beneficial for the teacher to have the ability to selectively show the entire class each student's situation, such as each student's cards in the case of poker, at the time of the teacher's choosing.

### SUMMARY OF THE INVENTION

The present invention is directed to a method and system for teaching a game of chance wherein at least one student participates in learning the game of chance remotely from the teacher, thereby providing a more flexible, convenient, and interactive learning experience, while also reducing the attendant costs.

The inventive method and system comprises hardware and software run on one or more computers and/or other type of machines, preferably linked together either with phone lines, high speed cable, wireless, etc. The aforementioned hardware and software of the present invention is thus utilized for interactive teaching and learning, such as for playing and demonstrating various games of chance, including live and archived presentations and video demonstrations thereof. Ideally, this software and hardware is structured to communicate with various interactive multimedia sources via the Internet. The aforesaid software and hardware is also preferably structured to allow for customization and control of game activity according to the teachers' and students' needs.

The system may assume a variety of physical and logical configurations, including a variety of computers under a number of different operating systems and network configurations. In a preferred embodiment, the system comprises a game teaching processor, a teacher interface, a student interface, and a network. In such an embodiment, the game teaching processor, teacher interface, and student interface are each disposed in a communicating relation with the network. The game teaching processor can comprise an Internet server, a desktop computer, or other computing device capable of hosting and handling communication and running multimedia interactive content. By way of example, the game teaching processor can manage participation of at least two thousand students and dozens of teachers simultaneously.

The teacher interface and student interface can each comprise a desktop computer, laptop or notebook computer, video game console, personal digital assistant, cell phone, or other handheld communication and computing device, including associated accessories such as speakers, headphones, visual displays, keypads, etc. Moreover, the teacher interface, student interface, and game teaching processor may each be located in a different location, remotely with respect to each other. As such, the network preferably comprises the Internet, although in other embodiments, the network could comprise a local area network or other type of network.

In various embodiments, the teacher interface comprises a number of functions and features which the teacher can use to teach and interact with the students. In at least one embodiment, the teacher interface comprises a teacher display structured to display a visual representation of one or more teachers. For example, the teacher display can be shown on a computer screen and depict a photograph of a teacher, a live video of the teacher, a multimedia trailer, a cartoon representation of the teacher, the teacher's company logo, etc.

The teacher interface further comprises a public audio feed structured to permit the teacher to talk to and listen to one or more students, and other teachers. Preferably, the public audio feed enables the teacher to talk to and/or listen to the entire class and other teachers simultaneously. Audio communication is performed in real-time.

The teacher interface additionally comprises a private audio feed structured to permit the teacher to talk privately to one or more students, and other teachers, so as not to disturb, embarrass, or otherwise communicate with an undesired party. The teacher interface also comprises a participant list structured to list and display the names of teachers and students participating in instruction, lessons, classes, seminars, etc. In at least one embodiment, the participant list displays text of the participants' names in addition to a color representation of each participant's role, such as blue for teachers and orange for students.

The teacher interface further comprises a bandwidth selecting capability structured to permit adjustment of network connection bandwidth. For example, network connections such as DSL, dial-up, cable, and T-1 can affect interactivity and performance for a given device. The present invention permits adaptation to such variations in network connection to optimize device performance.

The teacher interface further comprises a text messaging capability structured to permit text communication between the teachers and the students. By way of example, the text messaging capability can comprise a chat room where a teacher and a student can post comments to be received, viewed, and responded to by other participants.

The teacher interface also comprises a visual display structured to permit visual representation of multimedia content. For example, the visual display can be structured to display a game of chance being taught, such as poker, including representations of the game, the participants, students, teachers, representations of each player's bets and cards, the amount of credits for each participant, etc. In at least one embodiment, the visual display is further structured to permit operation and display of a drawing board, such that the teacher can interactively write and draw. The visual display can be further structured to permit operation and display of a multimedia slide show. By way of example, a pre-planned presentation of a lesson can be taught frame by frame in a slide show presentation before the students proceed to apply what they have learned by participating in a live, interactive game. In various embodiments, the visual display is further structured to permit the teacher to access, participate in, and display an interactive game on an online gaming site. The visual display can also be structured to permit display of live or prerecorded video. For example, prerecorded clips of a televised or privately recorded poker tournament can be selectively shown and discussed. Moreover, in at least one embodiment, the visual display can be further structured to display an advertisement of when a scheduled class or session begins, so that students and teachers can plan accordingly.

In at least one embodiment, the present invention further comprises a control panel customized for a particular type of game being taught in the style of an online game room. The control panel can include a variety of game control features. By way of example, the control panel can be customized for Texas Hold'em, though other types of games of chance are also within the scope of the present invention. In such an embodiment, the control panel may comprise, for example: a flop dealing capability, a 4th street dealing capability, a river dealing capability, a credit adjusting capability, a slideshow, a reset, a real poker link, a video player, and a drawing board.

The flop dealing, 4th street dealing, and river dealing capabilities permit the teacher to deal cards to individual participants at each respective stage of dealing Texas Hold'em. The credit adjusting capability permits the teacher to adjust the amount of credits of a selected student. The slideshow permits the teacher to present a slideshow lesson, such as a Powerpoint™ presentation. The reset enables the teacher to clear all cards in play so that a new hand can commence. The real poker link allows the teacher to access a predetermined internet poker room and display the poker room activity. The video player enables the teacher to play pre-recorded video content, such as a clip from a poker tournament. The drawing board permits the teacher to provide real-time descriptions, explanations, drawings, text, and other writings.

The student interface comprises many of the same or similar inventive aspects as the teacher interface. The student interface comprises a teacher display structured to display a visual representation of the one or more teachers. In at least one embodiment, students can pre-select the teacher of their choice. For example, a poker student may choose to participate in a lesson taught by one or more of their favorite Texas Hold'em celebrities. The student interface also comprises a public audio feed structured to permit the student to talk to one or more teachers and, in some embodiments, to the entire class. The student interface additionally comprises a private audio feed structured to permit the student to talk privately to one or more teachers, and, in some embodiments, to other students. This can enable a student to ask a question or make a comment without having to disturb the rest of the class. The student interface further comprises a bandwidth selecting capability structured to permit adjustment of network connection bandwidth. The student interface also comprises a text messaging capability structured to permit text communication between the student and the teacher and the student and other students. Moreover, the student interface comprises a visual display structured to permit visual representation of multimedia content.

Additionally, the student interface comprises an attention requesting capability which permits a student to notify the teacher that special attention is requested by the student. The notification can comprise, for example, a request for private communication. In other embodiments, the notification can comprise a self-evident request to elaborate on a specific point of discussion. Preferably, the attention requesting capability can initiate a graphical display of such a notification manifested via a visual display. In some embodiments, the attention requesting capability may also initiate audio or sounds.

These and other objects, features and advantages of the present invention will become clearer when the drawings as well as the detailed description are taken into consideration.

### BRIEF DESCRIPTION OF THE DRAWINGS

For a fuller understanding of the nature of the present invention, reference should be had to the following detailed description taken in connection with the accompanying drawings in which:

FIG. 1 is a schematic view of one preferred embodiment of the present invention having a network configuration.

FIG. 2 is a schematic view of a teacher interface in accordance with the present invention.

FIG. 2A is a schematic view of one feature of a visual display in accordance with the present invention.

FIG. 2B is a schematic view of a teacher interface card selector in accordance with the present invention.

FIG. 2C is a schematic view of a teacher interface control panel in accordance with the present invention.

FIG. 3 is a schematic view of a student interface in accordance with the present invention.

FIG. 4 is a high level logic flowchart of one aspect of a method for teaching a game of chance in accordance with the present invention.

FIG. 5 is a high level logic flowchart of another aspect of a method for teaching a game of chance in accordance with the present invention.

FIG. 6 is a high level logic flowchart of yet another aspect of a method for teaching a game of chance in accordance with the present invention.

Like reference numerals refer to like parts throughout the several views of the drawings.

### DETAILED DESCRIPTION OF THE PREFERRED EMBODIMENT

As shown in the accompanying figures, the present invention is directed to a method and system for teaching a game of chance wherein at least one student participates in learning the game of chance remotely from the teacher, thereby providing a more flexible, convenient, and interactive learning experience, while also reducing the attendant costs.

The inventive method and system comprises hardware and software run on one or more computers and/or other type of machines, preferably linked together either with phone lines, high speed cable, wireless, etc. The aforementioned hardware and software of the present invention is thus utilized for interactive teaching and learning, such as for playing and demonstrating various games of chance, including live and archived presentations and video demonstrations thereof. Ideally, this software and hardware is structured to communicate with various interactive multimedia sources via the Internet. As such, the present invention can be used in connection with related media, such as, for example, a separate “instruction room” within an online gaming site where players who are underperforming or losing money can go for instruction. The aforesaid software and hardware is also preferably structured to allow for customization and control of game activity according to the teachers' and students' needs.

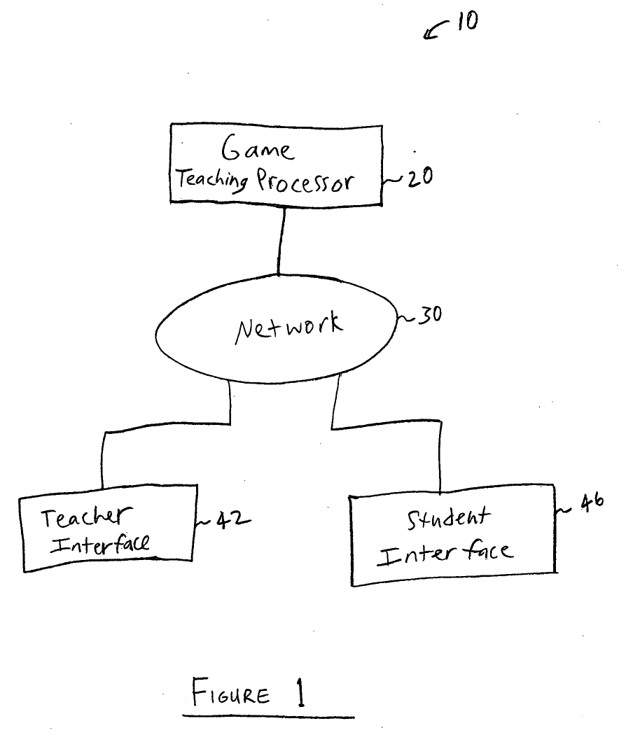

Referring now to the accompanying figures, in particular FIG. 1, a schematic of a system depicting a preferred embodiment of the present invention is generally indicated as 10. System 10 may assume a variety of physical and logical configurations, including a variety of computers under a number of different operating systems and network configurations. In this preferred embodiment, system 10 comprises a game teaching processor 20, a teacher interface 42, a student interface 46, and a network 30.

In further accordance with this represented embodiment, game teaching processor 20, teacher interface 42, and student interface 46 are each disposed in a communicating relation with network 30. Game teaching processor 20 can comprise an Internet server or a desktop computer, a mainframe computer, or other computing device capable of hosting and handling communication and running multimedia interactive content. By way of example, game teaching processor 20 can manage participation of at least two thousand students and dozens of teachers simultaneously. Teacher interface 42 and student interface 46 can each comprise a desktop computer, laptop or notebook computer, video game console, personal digital assistant, cell phone, or other handheld communication and computing device, including associated accessories such as speakers, headphones, visual displays, keypads, etc. Moreover, teacher interface 42, student interface 46, and game teaching processor 20 may each be located in a different location, remotely with respect to each other. As such, network 30 preferably comprises the Internet, although in other embodiments, network 30 could comprise a local area network or other type of network.

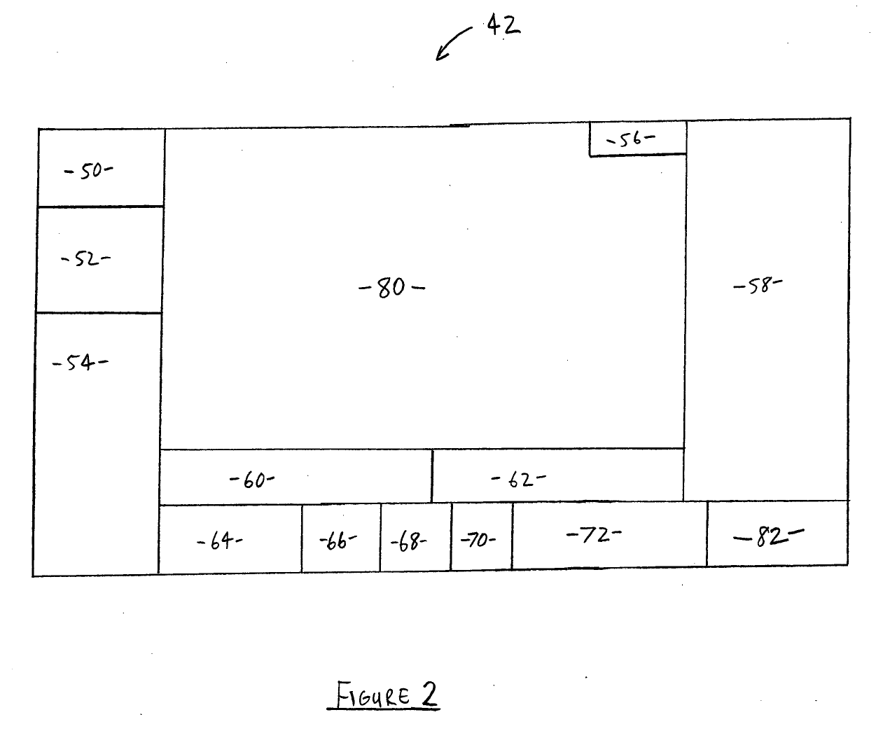

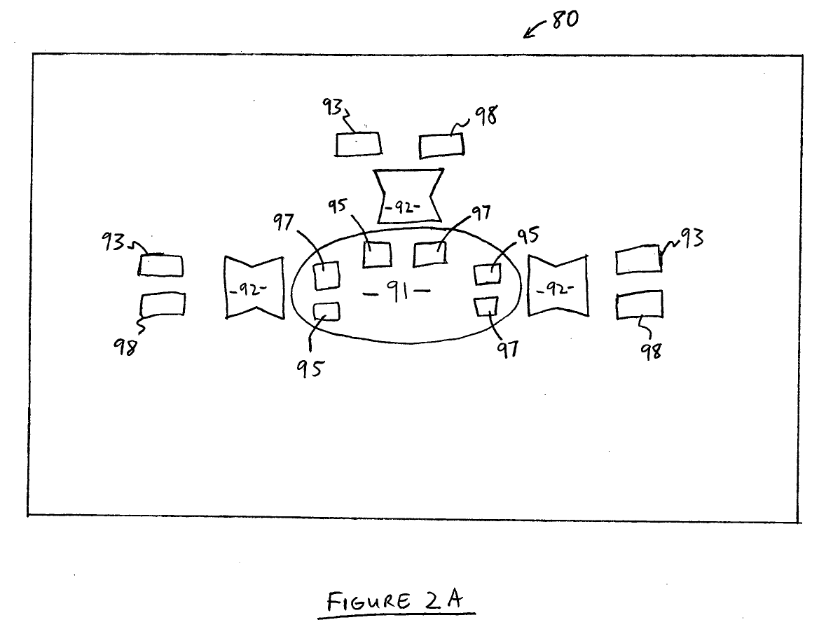

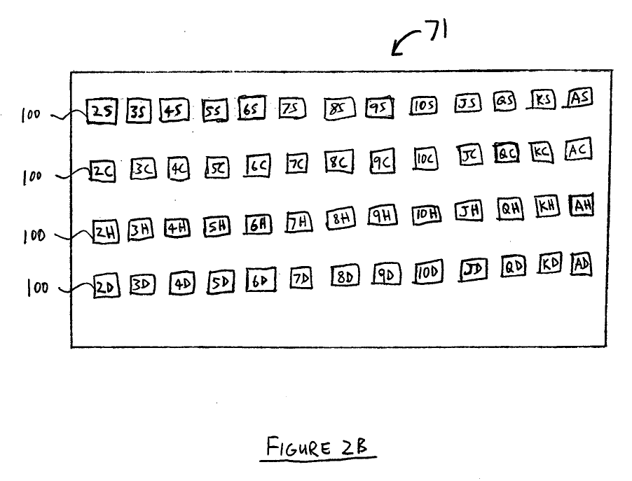

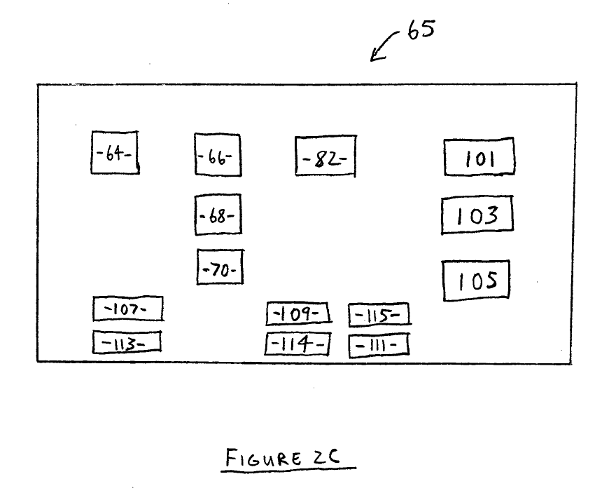

Turning now to FIG. 2, teacher interface 42 comprises a number of functions and features which the teacher can use to teach and interact with the students. Teacher interface 42 comprises a teacher display 50 structured to display a visual representation of one or more teachers. For example, teacher display 50 can be shown on a computer screen and depict a photograph of a teacher, a live video of the teacher, a multimedia trailer, a cartoon representation of the teacher, the teacher's company logo, etc.

Teacher interface 42 further comprises a public audio feed 52 structured to permit the teacher to talk to and listen to one or more students, and other teachers. Preferably, public audio feed 52 enables the teacher to talk to and/or listen to the entire class and other teachers selectively or simultaneously. Audio communication is performed in real-time. Public audio feed 52 further permits adjustment of audio parameters such as volume, echo, etc., and can also be muted both for incoming and outgoing audio.

Teacher interface 42 additionally comprises a private audio feed 72 structured to permit the teacher to talk privately to one or more students, and other teachers, so as not to disturb, embarrass, or otherwise communicate with an undesired party. Audio communication is performed in real-time. Private audio feed 72 further permits adjustment of audio parameters such as volume, echo, etc., and can also be muted both for incoming and outgoing audio.

Teacher interface 42 also comprises a participant list 54 structured to list and display the names of teachers and students participating in instruction, lessons, classes, seminars, etc. In at least one embodiment, participant list 54 displays text of the participants' names in addition to a color representation of each participant's role, such as blue for teachers and orange for students.

Teacher interface 42 further comprises a bandwidth selecting capability 56 structured to permit adjustment of network connection bandwidth. For example, network connections such as DSL, dial-up, cable, and T-1 can affect interactivity and performance for a given device. The present invention permits adaptation to such variations in network connection to optimize device performance.

Teacher interface 42 further comprises a text messaging capability 58 structured to permit text communication between the teachers and the students. By way of example, text messaging capability 58 can comprise a chat room where a teacher and a student can post comments to be received, viewed, and responded to by other participants.

Teacher interface 42 also comprises a visual display 80 structured to permit visual representation of multimedia content. For example, visual display 80 can be structured to display a game of chance, such as poker, including representations of the game, the participants, students, teachers, etc. More specifically, as depicted in FIG. 2A, visual display 80 can be structured to display a poker table 91, representing seats 92 of the participants in the game and the corresponding identification 93 and location of the various teachers and students, representations of each player's bets 95 and cards 97, the amount of credits 98 for each participant, etc. By way of example, FIG. 2A depicts a visual display 80 representing three participants, though the scope of the present invention includes any number of participants. In at least one embodiment, visual display 80 is further structured to permit operation and display of a drawing board, such that the teacher can interactively write and draw. Visual display 80 can be further structured to permit operation and display of a multimedia slide show, such as PowerPoint®. By way of example, a pre-planned presentation of a lesson can be taught frame by frame in a slide show presentation before the students proceed to apply what they have learned by participating in a live, interactive game also in connection with visual display 80. In various embodiments, visual display 80 is further structured to permit the teacher to access, participate in, and display an interactive game on an online gaming site. Visual display 80 can also be structured to permit display of live or prerecorded video. For example, prerecorded clips of a televised or privately recorded poker tournament can be selectively shown and discussed. Moreover, in at least one embodiment, visual display 80 is further structured to display an advertisement of when a scheduled class or session begins, so that students and teachers can plan accordingly.

Referring again to FIG. 2, teacher interface 42 additionally comprises a sound effect capability 60 structured to produce sounds in connection with plays, student and teacher emotions, etc., either in conjunction with visual display 80 or independently from visual display 80. For example, a sound effect capability 60 might produce a bell ringing sound, a clapping sound, or a gunshot sound in connection with a play, though virtually any sound imaginable may be produced. The teacher may manually operate or pre-program the sound effect capability 60. For example, some sounds may react to certain predetermined plays or other stimuli, while other sounds may be initiated by the teacher clicking on a virtual button. Further, sound effect capability 60 permits adjustment of qualities and properties of the sounds, including the type and duration of sound as well as the volume of the sound.

Teacher interface 42 also comprises a play list 62 structured to permit visual representation of play activity in the game of chance. Preferably, play list 62 displays a text representation of each step of a game. For example, in the case of poker, play list 62 can display in real-time a text representation of the commencement of the game, the dealing of cards, the status of community cards, the identity of the player and the status of their play, any hands dealt, the bet or fold, the end of the game, etc., as each respective action takes place.

In at least one embodiment, teacher interface 42 further comprises a bet timer 64 structured to control the amount of time a student or other participant has to make a bet, which can aid the teacher in maintaining order and instructional efficiency.

Likewise, in order to maintain order and efficiency, in at least one embodiment, teacher interface 42 is additionally structured to permit control of when the game begins. For example, teacher interface 42 may comprise a starter 66 structured to commence play.

In at least one embodiment, wherein the game being taught comprises a game of poker, teacher interface 42 comprises a dealer control 70 structured to permit adjustment of dealt cards. In this embodiment, dealer control 70 permits dealing of random cards as well as selective dealing of predetermined cards. Moreover, a combination of dealing random and predetermined cards may be implemented by the teacher. For example, in a game of Texas Hold'em poker, the teacher may wish to select random cards to deal to participating students via dealer control 70. Further, the teacher may wish to deal the community cards such that the community cards are selectively predetermined in order to illustrate a point, or to discuss strategy, etc. In such a case, the teacher can use dealer control 70 to deal individually pre-selected cards to predetermined recipients. In at least one embodiment, the dealer control 70 may comprise an interactive graphic card selector 71, which depicts a full deck of cards 100, as shown in FIG. 2B, from which the teacher can select a card 100, and subsequently deliver the selected card 100 to the intended player.

In at least one embodiment, teacher interface 42 additionally comprises a card revealing capability 68 structured to permit the teacher to show cards to the students when the teacher chooses to do so. For example, card revealing capability 68 can permit the teacher to show all students all cards at the table in the middle of a hand or before or after a bet so as to illustrate projected winning percentages, strategies, etc.

Teacher interface 42 further comprises a recording capability 82 structured to permit recording of teaching sessions. Recorded content can include, without limitation, implementation of slide shows, drawing boards, live games, demonstration games, videos of tournament action, etc. Portions of teaching sessions or entire sessions can be recorded, stored, played and shared. The recording capability 82 further permits recording of diverse multimedia activity associated with a teaching session, including audio, video, etc., either individually or in combination. For example, in one embodiment, audio content is recorded separately in an audio friendly format, such as MP3.

In the embodiment represented in FIG. 2C, the present invention further comprises a control panel 65 customized for a particular type of game. Control panel 65 can include a variety of game control features, including the various features discussed above. By way of example, control panel 65 is customized for Texas Hold'em poker, though other types of games of chance are also within the scope of the present invention. In this embodiment, control panel 65 comprises a flop dealing capability 101, a 4th street dealing capability 103, a river dealing capability 105, a credit adjusting capability 107, a slideshow 109, a reset 111, a real poker link 113, a video player 114, and a drawing board 115.

The flop dealing 101, 4th street dealing 103, and river dealing 105 capabilities permit the teacher to deal cards to individual participants at each respective stage of dealing Texas Hold'em. Credit adjusting capability 107 permits the teacher to adjust the amount of credits of a selected student. Slideshow 109 permits the teacher to present a slideshow lesson, such as a Powerpoint™ presentation. Reset 111 enables the teacher to clear all cards in play so that a new hand can commence. Real poker link 113 allows the teacher to access a predetermined internet poker room and display the poker room activity. Video player 114 enables the teacher to play pre-recorded video content, such as a clip from a poker tournament. Drawing board 115 permits the teacher to provide real-time descriptions, explanations, drawings, text, and other writings.

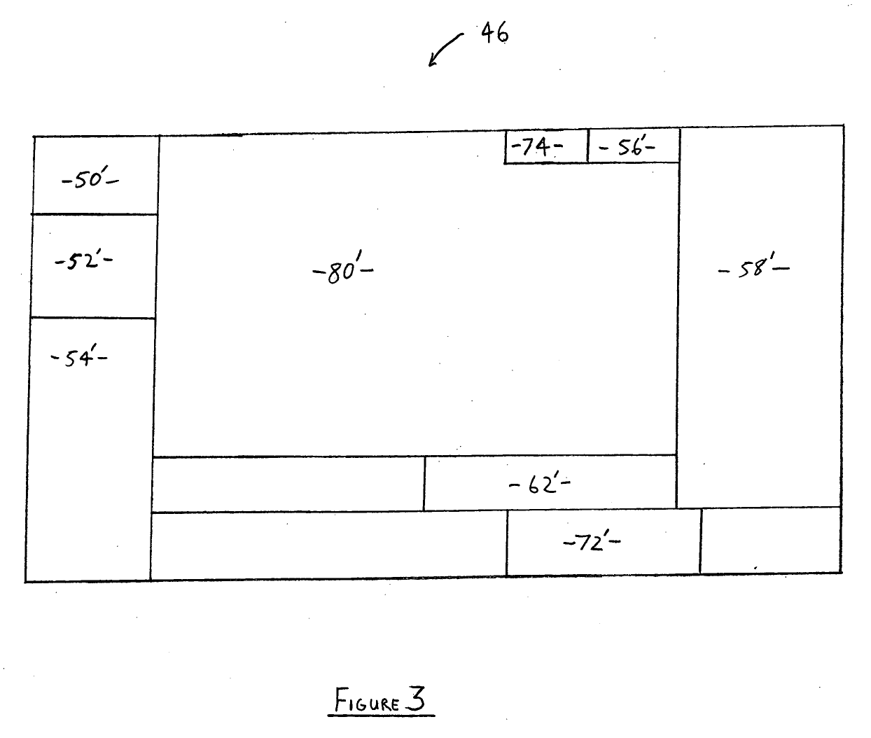

Referring now to FIG. 3, student interface 46 comprises many of the same or similar inventive aspects as teacher interface 42. Student interface 46 comprises a teacher display 50′ structured to display a visual representation of the one or more teachers. In at least one embodiment, students can pre-select the teacher of their choice. For example, a poker student may choose to participate in a lesson taught by one or more of their favorite Texas Hold'em celebrities. Student interface 46 also comprises a public audio feed 52′ structured to permit the student to talk to one or more teachers and, in some embodiments, to the entire class. Student interface 46 additionally comprises a private audio feed 72′ structured to permit the student to talk privately to one or more teachers, and, in some embodiments, to other students. This can enable a student to ask a question or make a comment without having to disturb the rest of the class. Student interface 46 further comprises a bandwidth selecting capability 56′ structured to permit adjustment of network connection bandwidth. Student interface 46 also comprises a text messaging capability 58′ structured to permit text communication between the student and the teacher and the student and other students. Moreover, student interface 46 comprises a visual display 80′ structured to permit visual representation of multimedia content. Additionally, student interface 46 comprises a play list 62′ structured to permit visual representation of play activity in the game of chance. The foregoing described functions and features of student interface 46 generally comprise the same or similar aspects and variations as those of teacher interface 42.

Additionally, student interface 46 comprises an attention requesting capability 74 which permits a student to notify the teacher that special attention is requested by the student. The notification can comprise, for example, a request for private communication. In other embodiments, the notification can comprise a self-evident request to elaborate on a specific point of discussion. Preferably, the attention requesting capability 74 can initiate a graphical display of such a notification manifested via visual display 80, 80′. In some embodiments, attention requesting capability 74 may also initiate audio or sounds.

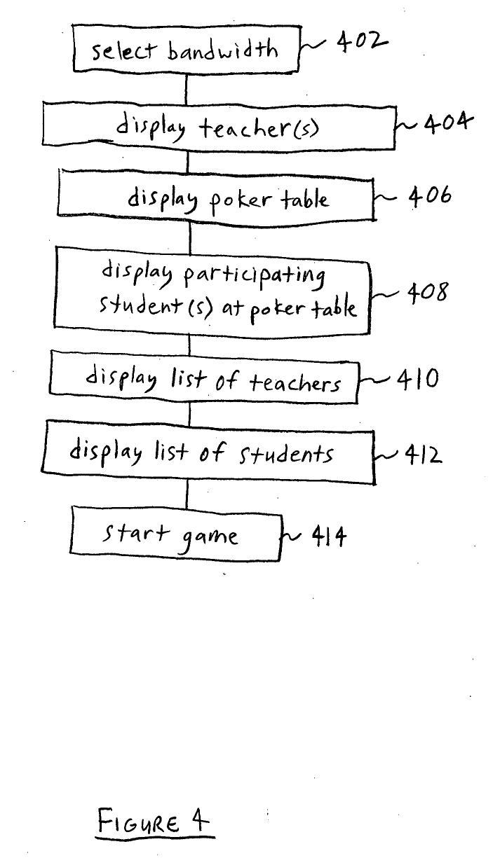

Referring now to FIGS. 4, 5, and 6, there are depicted high level logic flowcharts of the method of the present invention, specifically with respect to interactively teaching a game of poker; however, the present invention is not limited to such embodiments. As discussed previously, the teacher may also choose to present other content to students, such as, but not limited to, a drawing board presentation, a slideshow presentation, or a video.

With reference to FIG. 4, there is depicted a high level logic flow chart associated with a method of commencing an interactive teaching session in accordance with the present invention. As illustrated, the method starts at block 402 and thereafter proceeds to block 404. Block 402 depicts the selecting of connection bandwidth. The selecting of connection bandwidth permits adjustment of network connection bandwidth to optimize the communication operability of the equipment being used. For example, if a teacher is conducting a lesson from a laptop computer connected to the Internet via a cable modem, a connection bandwidth for a cable modem can be selected to ensure optimal connectivity; whereas if the laptop computer is connected to the Internet via DSL, the connection bandwidth for DSL can be selected for optimal connectivity.

Block 404 depicts displaying an image representing the teacher. For example, a video, picture, cartoon, or other visual image can be displayed, including a logo. To illustrate the interactive teaching of a game of poker, Block 406 depicts displaying a poker table. As discussed above, in at least one embodiment, a top view of a poker table is displayed including cards, chips, and other interactive elements of the game. Further, Block 408 depicts displaying images representing students, or other participants. To illustrate, colored chairs, cartoon representations, text-based names, photos, etc., or combinations of such representations, can be displayed in a manner that corresponds to each respective student situated in a particular location about the poker table. Block 410 depicts displaying a list of teachers, and Block 412 depicts displaying a list of students, which identifies the interactive participants. As discussed above, the display of lists of teachers and students can include, for example, text as well as logos or colors. Moreover, the lists can change as teachers and students are added or removed. It should be understood that the method of blocks 402 through 412 can be applied to a teacher interface as well as a student interface.

Continuing with the example of interactively teaching a game of poker, the teacher starts the game, as at Block 414. In at least one embodiment, the game is commenced after at least one teacher and at least one student have connected at the appropriate bandwidth, and the participants and the elements of the game are appropriately displayed and listed. Preferably, the teacher manually starts the game, although the game can also be started in an automated manner.

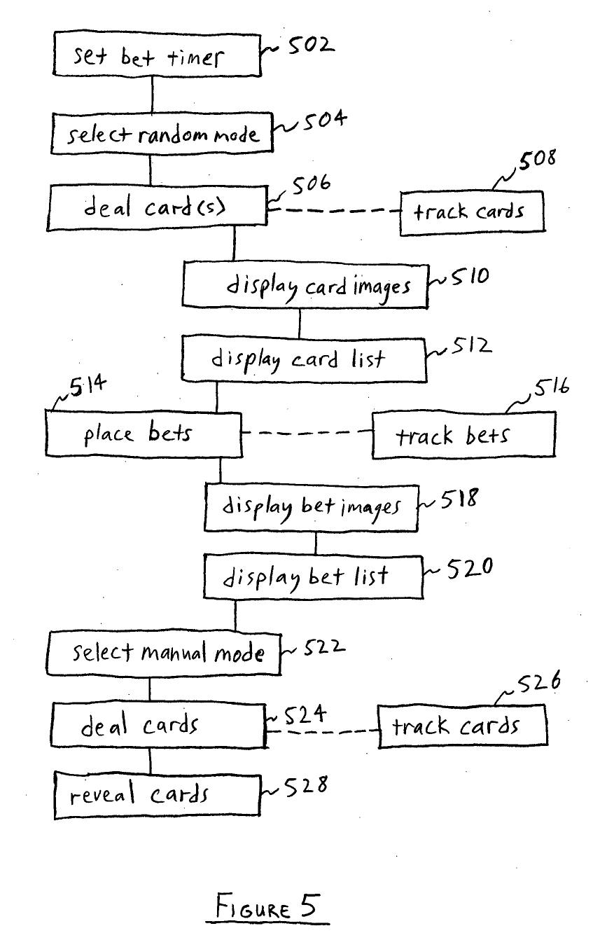

With reference to FIG. 5, there is depicted a high level logic flow chart associated with a method of conducting an interactive teaching session of a game of poker in accordance with the present invention. As illustrated, the method starts at Block 502 and thereafter proceeds to Block 504. Block 502 depicts the setting of a bet timer by the teacher. Setting a bet timer permits the teacher to manage the pace of the game as deemed necessary. Block 504 depicts the teacher selecting a random card mode for dealing one or more cards to one or more participants. Typically the participants are students, although, in some cases, one or more teachers can participate in the game as well. In some embodiments, all of the students participate in the game, while in other embodiments some students merely observe rather than participate. In still other embodiments, students take turns participating in the game. Block 506 depicts dealing one or more cards to one or more participants. Block 508 depicts tracking the cards dealt, which can include, for example, tracking the particular cards received by each participant, as well as tracking the cards remaining in a particular deck being utilized for the game. Block 510 depicts displaying images of the cards. In at least one embodiment, images of the cards can be displayed face down, face up, and together as a hand, in accordance with the particular rules of the game being played. For example, in Texas Hold'em, community cards such as the flop and the river may be displayed face up, while participants' hands are displayed face down until the appropriate time to reveal their face. Block 512 depicts displaying a list of the cards. In at least one embodiment, a text-based visual representation of the list of the cards can be displayed. By way of example, known, face up cards can be explicitly described in the list, such as “ace of hearts” while hidden cards can be referenced generally, such as “in play” or “folded.”

Block 514 depicts placing bets by the participants. By way of example, some students may fold, while others may make a wager. Block 516 depicts tracking the bets, which can include, for example, tracking each bet individually as well as tracking the accumulation of each bet throughout a game. Block 518 depicts displaying images of the bets, such as representations of coins, cash, chips, or numbers. Furthermore, Block 520 depicts displaying a list of the bets, such as a text representation of the amount of the bet wagered by each respective participant.

Block 522 depicts selecting a manual dealing mode which enables selective dealing of one or more cards to one or more participants. By pre-selecting specific cards for predetermined players and hands, the teacher can demonstrate various strategies, discuss odds or percentages of certain plays, predict resulting outcomes, etc. Accordingly, Block 524 depicts dealing the manually selected cards, and Block 526 depicts tracking the dealt cards, discussed above.

Block 528 depicts the feature of revealing all cards involved in a game so that the characteristics of non-revealed cards are revealed to other participants. The cards revealed can include, without limitation, cards in the participants' respective hands, community cards, and cards in the deck from which the other cards were dealt. For example, the teacher can reveal all cards at a time of the teacher's choosing in order to illustrate various plays, positions, strategies, etc.

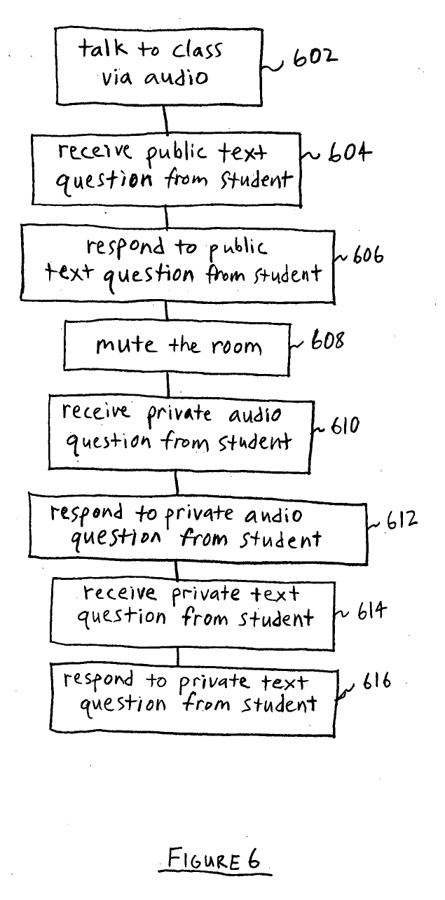

Turning to FIG. 6, there is depicted a high level logic flow chart associated with some interactive communication aspects of a method of teaching a game of chance in accordance with the present invention. As illustrated, this aspect of the method starts at block 602 and thereafter proceeds to block 604. Block 602 depicts talking to an entire class via audio communication. As discussed above, a teacher can talk to and listen to all of the students and other teachers via an audio feed. For example, in conjunction with demonstrating a series of poker plays in a slideshow presentation, the teacher can simultaneously lecture to the participants.

Block 604 depicts receiving a public text question from a student. For example, the teacher may receive a public text question from a student or other participant via an Internet chat room. Moreover, the teacher may respond to the public question from the student, as depicted in Block 606. Indeed, the teacher may choose to respond publicly or privately. Communicating via public text provides an additional learning resource that students can utilize as they choose.

Block 608 depicts muting the reception of the public audio feed. To illustrate, a teacher or student can mute the public audio feed on their respective interface to provide silence when there is otherwise incoherent chatter or noise being received from the various connections comprising a “virtual game room.”

Block 610 depicts receiving a private audio question from a student. Some students may prefer to ask a question in private rather than bother the rest of the class. As such, after receiving a private audio question, the teacher can, as depicted in Block 612, respond privately to the question from the student. In at least one embodiment, the response can be via private audio feed or private text, or both. The teacher can also receive a private text question from a student, as at Block 614, and respond privately to the question from the student, as at Block 616. Again, in at least one embodiment, the response can be via private audio feed or private text. Furthermore, as elaborated above, the private text communication can occur, for example, via a chat room.

Although much of the above discussion embodies poker, and specifically Texas Hold'em, the present invention is not limited to such embodiments. For example, the present invention also pertains to other games of chance, such as, without limitation, blackjack, bridge, Omaha, raz, roulette, craps, and slot machines.

Since many modifications, variations and changes in detail can be made to the described preferred embodiment of the invention, it is intended that all matters in the foregoing description and shown in the accompanying drawings be interpreted as illustrative and not in a limiting sense. Thus, the scope of the invention should be determined by the appended claims and their legal equivalents.

Now that the invention has been described,

What is claimed is:

1. A method of teaching a game of chance, comprising:
providing interactive educational instruction relating to a game of chance;
directing the interactive educational instruction via at least one teacher interface to at least one student interface situated remotely from the at least one teacher interface; and
communicating with the at least one student interface in real-time via the at least one teacher interface.

2. A method as recited in claim 1 further comprising permitting adjustment, via the at least one teacher interface, of at least one factor affecting the outcome of the game of chance.

3. A method as recited in claim 1 further comprising establishing public real-time communication between the at least one student interface and the at least one teacher interface.

4. A method as recited in claim 1 further comprising establishing private real-time communication between the at least one student interface and the at least one teacher interface.

5. A method as recited in claim 1 further comprising recording a teaching session.

6. A method as recited in claim 1 further comprising displaying interactive multimedia content on both the teacher interface and the student interface.

7. A method as recited in claim 6 defining the interactive multimedia content as comprising a slide show presentation.

8. A method as recited in claim 6 defining the interactive multimedia content as comprising an online game room.

9. A method as recited in claim 6 defining the interactive multimedia content as comprising a drawing board.

10. A method as recited in claim 6 defining the interactive multimedia content as comprising a video clip.

11. A method of teaching a card game, comprising:
providing interactive educational instruction relating to a card game;
directing the interactive educational instruction via at least one teacher interface to at least one student interface situated remotely from the at least one teacher interface;
communicating with the at least one student interface in real-time via the at least one teacher interface; and
permitting adjustment, via the at least one teacher interface, of at least one factor affecting the outcome of the card game.

12. A method as recited in claim 11 defining the card game as Texas Hold'em poker.

13. A method as recited in claim 11 wherein permitting adjustment of the at least one factor affecting the outcome of the card game further comprises dealing one or more cards via the at least one teacher interface.

14. A method as recited in claim 13 wherein the dealing one or more cards comprises dealing one or more predetermined cards via the at least one teacher interface.

15. A method as recited in claim 13 wherein the dealing one or more cards comprises dealing one or more random cards via the at least one teacher interface.

16. A method as recited in claim 13 further comprising tracking the one or more cards.

17. A method as recited in claim 11 further comprising tracking the one or more cards.

18. A method as recited in claim 11 further comprising tracking one or more bets.

19. A method as recited in claim 11 further comprising displaying interactive multimedia content on both the teacher interface and the student interface.

20. A method as recited in claim 11 further comprising recording a teaching session.

21. A system for teaching a game of chance, comprising:
a game teaching processor in communication with a network;
at least one student interface in communication with the network;
at least one teacher interface in communication with the network;
said game teaching processor structured to facilitate interactive educational instruction relating to a game of chance;
said at least one student interface structured to display interactive multimedia content, and further structured to communicate with the at least one teacher interface in real-time; and
said at least one teacher interface structured to display interactive multimedia content, and further structured to communicate with the at least one student interface in real-time.

22. A system as recited in claim 21 wherein said at least one teacher interface, said at least one student interface, said game teaching processor, and said network are structured to operate over the Internet.

23. A system as recited in claim 21 wherein said real-time communication comprises private communication.

24. A system as recited in claim 21 wherein said real-time communication comprises public communication.

25. A system as recited in claim 21 wherein said game teaching processor is further structured to record a teaching session.

26. A system as recited in claim 21 wherein said interactive multimedia content comprises a slide show presentation.

27. A system as recited in claim 21 wherein said interactive multimedia content comprises an online game room.

28. A system as recited in claim 21 wherein said interactive multimedia content comprises a drawing board.

29. A system as recited in claim 21 wherein said interactive multimedia content comprises a video clip.

30. A system as recited in claim 21 wherein the teacher interface is further structured to permit adjustment of at least one factor affecting the outcome of said game of chance.

31. A system as recited in claim 21 wherein said game of chance comprises a card game.

32. A system as recited in claim 31 wherein said card game is Texas Hold'em Poker.

33. A system as recited in claim 31 wherein said at least one teacher interface is further structured to deal one or more predetermined cards.

34. A system as recited in claim 31 wherein said at least one teacher interface is further structured to deal one or more random cards.

35. A system as recited in claim 31 further structured to track the one or more cards.

36. A system as recited in claim 31 further structured to track one or more bets.

37. A system for teaching a card game, comprising:
at least one teacher interface in communication with a network;
at least one student interface in communication with the network;
said at least one teacher interface structured to facilitate interactive multimedia teaching relating to a card game, and further structured to communicate with the at least one student interface in real-time;
said at least one student interface structured to facilitate interactive multimedia learning relating to a card game, and further structured to communicate with the at least one teacher interface in real-time;
said at least one teacher interface further comprising at least one processor structured to run at least one computer program for facilitating interactive multimedia teaching relating to the card game; and
said at least one student interface further comprising at least one processor structured to run at least one computer program for facilitating interactive multimedia learning relating to the card game.

38. A system as recited in claim 37 wherein said real-time communication comprises private communication.

39. A system as recited in claim 37 wherein said real-time communication comprises public communication.

40. A system as recited in claim 37 wherein said at least one teacher interface is further structured to permit recording of a lesson.

41. A system as recited in claim 37 wherein said at least one student interface is further structured to permit recording of a lesson.

42. A system as recited in claim 37 wherein said at least one teacher interface is further structured to permit dealing of one or more predetermined cards.

43. A system as recited in claim 37 wherein said at least one teacher interface is further structured to permit dealing of one or more random cards.

44. A system as recited in claim 37 wherein said at least one teacher interface is further structured to permit tracking of one or more cards.

45. A system as recited in claim 37 wherein said at least one teacher interface is further structured to permit tracking of one or more bets.
